(19) United States
(12) Patent Application Publication
(10) Pub. No.: US 2025/0287183 A1
(43) Pub. Date: Sep. 11, 2025

(54) HANDLING PRIVILEGES WHILE CHANGING GEOGRAPHICAL REGIONS

(71) Applicant: QUALCOMM Incorporated, San Diego, CA (US)

(72) Inventors: Bapineedu Chowdary GUMMADI, Hyderabad, Telangana (IN); Stephen William EDGE, Escondido, CA (US); Bala RAMASAMY, San Marcos, CA (US); Yatham Sai Sangram REDDY, Bangalore, Karnataka (IN); Amarnath Reddy POTHIREDDY, Hyderabad, Telangana (IN); Suryakanta MANDAL, Hyderabad, Telangana (IN)

(21) Appl. No.: 18/862,171

(22) PCT Filed: Jun. 28, 2023
(86) PCT No.: PCT/US2023/026412

§ 371 Date: Nov. 1, 2024

(30) Foreign Application Priority Data
Jul. 20, 2022 (IN) 202241041640

(51) Int. Cl. H04W 4/029; G08G 1/09; G08G 1/0967; H04L 67/12; H04W 4/021; H04W 4/40

(52) U.S. Cl. CPC H04W 4/029; H04L 67/12; H04W 4/021; H04W 4/40; G08G 1/091; G08G 1/096766

(57) ABSTRACT

Techniques for handling vehicle privileges while changing geographical regions are disclosed. In some embodiments, a user equipment (UE) may be configured to, based on a determination that the UE is within a first geographical region associated with a first authority, receive first privilege information from a first wireless node within the first geographical region; based on a determination that the UE is within an overlapping region, operate the UE according to the first set of behavioral rules; and receive second privilege information from the second wireless node within the second geographical region, the second privilege information configured to enable the UE to operate according to a second set of behavioral rules determined by the second authority while within the second geographical region and not within the overlapping region.

### RELATED APPLICATIONS

This application claims priority to and the benefit of Indian application Ser. No. 20/224,1041640, filed Jul. 20, 2022, entitled “HANDLING VEHICLE PRIVILEGES WHILE CHANGING GEOGRAPHICAL REGIONS”, which is assigned to the assignee hereof, and incorporated herein in its entirety by reference.

### BACKGROUND

### 1. Field of Disclosure

The present disclosure relates generally to the field of wireless communications, and more specifically to granting privileges specific to user equipment (UE) and geographic location.

### 2. Description of Related Art

Different authorities and regulatory entities may govern different geographical regions (country, state, county, city, province, etc.). These authorities may impose different rules relating to UEs that are within the governed region. For example, rules for usage of UEs or privileges or restrictions granted to UEs may vary depending on parameters, e.g., the type of UE, or its location. In particular, a vehicle can be given a special privilege upon meeting a condition or upon a request to the specific authority governing the geographic region in which the vehicle is located. Such privileges may include, among other things, access to certain lanes or enhanced traffic rules.

### BRIEF SUMMARY

In one aspect of the present disclosure, a method of receiving privileges at a user equipment (UE) is disclosed. In some embodiments, the method includes: based on a determination that the UE is within a first geographical region associated with a first authority, receiving first privilege information from a first wireless node within the first geographical region, the first privilege information comprising a first set of behavioral rules determined by the first authority; based on a determination that the UE is within an overlapping region, the overlapping region within a communication range of the first wireless node within the first geographical region and a communication range of a second wireless node within a second geographical region associated with a second authority, operating the UE according to the first set of behavioral rules; and receiving second privilege information from the second wireless node within the second geographical region, the second privilege information configured to enable the UE to operate according to a second set of behavioral rules determined by the second authority while within the second geographical region and not within the overlapping region.

In another aspect of the present disclosure, a user equipment (UE) is disclosed. In some embodiments, the UE includes: a memory; and one or more processors communicatively coupled to the memory and configured to: based on a determination that the UE is within a first geographical region associated with a first authority, receive first privilege information from a first wireless node within the first geographical region, the first privilege information comprising a first set of behavioral rules determined by the first authority; based on a determination that the UE is within an overlapping region, the overlapping region within a communication range of the first wireless node within the first geographical region and a communication range of a second wireless node within a second geographical region associated with a second authority, operate the UE according to the first set of behavioral rules; and receive second privilege information from the second wireless node within the second geographical region, the second privilege information configured to enable the UE to operate according to a second set of behavioral rules determined by the second authority while within the second geographical region and not within the overlapping region.

In another aspect of the present disclosure, a non-transitory computer-readable apparatus is disclosed. In some embodiments, the non-transitory computer-readable apparatus includes a storage medium, the storage medium having instructions configured to, when executed by one or more processors, cause a user equipment (UE) to: based on a determination that the UE is within a first geographical region associated with a first authority, send first privilege information to a wireless node associated with the first geographical region, the first privilege information comprising a first set of behavioral rules determined by the first authority; operate the UE based on the first set of behavioral rules within the first geographical region; based on a determination that the UE is within an overlapping region, the overlapping region within a communication range of the first wireless node within the first geographical region and a communication range of a second wireless node within a second geographical region associated with a second authority, continue to operate the UE according to the first set of behavioral rules; and initiate communication with the second wireless node within the second geographical region to send second privilege information to the second wireless node, the second privilege information configured to enable the UE to operate according to a second set of behavioral rules determined by the second authority while within the second geographical region and not within the overlapping region.

In another aspect of the present disclosure, an apparatus is disclosed. In some embodiments, the apparatus includes: means for determining, by a wireless node within a first geographical region, a presence of a user equipment (UE) within a communication range of the wireless node; and means for sending, by the wireless node, privilege information to the UE, privilege information configured to enable the UE to operate according to a set of behavioral rules associated with the first geographical region while the UE is within the first geographical region or within an overlap region that is created by a communication range of the wireless node and a communication range of another wireless node of another geographical region.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication network.

FIG. 3A illustrates an example scenario in which a user equipment (UE, e.g., vehicle) traversing between a first geographical region and a second geographical region communicates with one or more base stations (including RSUs), according to some embodiments.

FIG. 3B illustrates a view of the UE (e.g., vehicle) within a coverage area of an RSU within the first geographical region, according to some embodiments.

FIG. 3C illustrates a view of the UE (e.g., vehicle) within an overlapping region near the boundary separating the first geographical region and the second geographical region, according to some embodiments.

FIG. 4 illustrates another example scenario in which a UE traversing between a first geographical region and a second geographical region along a path communicates with one or more base stations (including RSUs), according to some embodiments.

FIG. 5 is a flow diagram of a method of receiving privileges at a UE, according to some embodiments.

FIG. 6 is a flow diagram of another method of sending privilege information with a UE, according to some embodiments.

FIG. 7 is a flow diagram of a method of granting privileges to a UE, according to some embodiments.

FIG. 8 is a block diagram of an embodiment of a UE, which can be utilized in embodiments as described herein.

FIG. 9 is a block diagram of an embodiment of a base station (e.g., RSU), which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein may absolute location determination, relative location determination, ranging, or a combination thereof. Such positioning may include and/or be based on timing, angular, phase, or power measurements, or a combination thereof (which may include RF sensing measurements) for the purpose of location or sensing services.

A privilege-granting authority (also referred to herein as the “authority”) may vary in different situations and circumstances. In general, the privilege-granting authority may correspond to an organization which controls the infrastructure like a government, a local authority for a town, city or state, or a private entity, e.g. to which a government or local authority might have outsourced the management of vehicle related privileges (e.g. road privileges). A signed document may then be applicable only in a corresponding region of control of the respective privilege-granting authority. In some instances, a signed document can be applicable to multiple jurisdictions based, for example, on an existing mutual agreement between respective privilege-granting authorities for those jurisdictions. Thus, if a vehicle moves from a region governed by one authority to a region governed by another authority, it may request different privileges (or signed documents) from different authorities or may be able to use a signed document provided by one authority in regions governed by other authorities. For example, if a vehicle moves from one state to another or across multiple states, the vehicle may need to request multiple signed documents if the states are governed by different authorities or may possibly be enabled to use one signed document in all states, e.g. if the signed document was provided by a national authority. It can be noted that the region or jurisdiction of an authority may not be strictly defined by definite boundaries because it may be difficult to define an accurate boundary. The jurisdiction of an authority may be determined by wireless nodes, for example, rather than strictly defined territorial boundaries. Thus, there may be an intersection or an overlap between regions where two (or more) authorities can govern control, in which case a signed document from either (or any) of the authorities may be deemed valid.

As described above and as used herein, the term “signed document” refers to a document that indicates one or more privileges and/or priorities assigned temporarily or permanently to a vehicle, a device associated with a vehicle (e.g. a modem or “in vehicle system” used for communications) or a device belonging to a user (e.g., a user equipment (UE), operator or passenger of a vehicle. The terms “privilege certificate,” “certificate,” or “privilege information” may be used interchangeably to refer to a “signed document.” The signed document or the privilege certificate may include digital data representative of the one or more privileges and/or priorities. For example, the document or certificate may explicitly list and name each of the one or more privileges and/or priorities, or the document may contain an encoding (e.g. a binary ASN.1 encoding) of each of the one or more privileges and/or priorities. The document may be a text document (e.g. encoded as unformatted text and possibly using the Extensible Markup Language (XML)) or a binary document (e.g. encoded using the Abstract Syntax Notation One (ASN.1)). The document can be signed using a digital signature, e.g. which may be based on a public key-private key pair, where the digital signature may comprise a ciphering using the private key of a hash (based on a known or identified hash algorithm) of the contents of the document. The document may be authenticated by a recipient of the document by verifying the digital signature. For example, for a digital signature based on a public key-private key pair as just described, the recipient may decrypt the digital signature using the public key and verify the decrypted result matches a hash of the document, which may be obtained by the recipient using the same known or identified hash algorithm. In this example, the public key used by the recipient to verify the digital signature may be provided and authenticated by one or more digital certificates, e.g. digital certificates defined according to ITU X.509 or IETF RFC 5280, which may be provided along with the document and the digital signature. The collection comprising the document indicating the one or more privileges and/or priorities related to a vehicle, the digital signature and the one or more digital certificates, if included, is referred to herein as a “signed document”. A signed document may also be referred to as a certificate, a signed certificate, or a privilege certificate. The use of digital signatures (e.g. based on public key-private key pairs) to authenticate documents and the use of digital certificates to provide and authenticate public keys is widely known in the art. It is noted that the term “unsigned document” is used herein to refer to a document indicating one or more privileges and/or priorities related to a vehicle but without a digital signature or one or more digital certificates.

Depending on desired functionality, a signed document may be granted and used in different ways. In some cases, user equipment (UE) may be co-located with a vehicle. A vehicle receiving privileges via the signed document may include a permanent or temporary onboard UE with Vehicle-to-everything (V2X) wireless communications capability. In such instances, a signed document enabling the privileges may be permanently or temporarily configured in the onboard UE. Alternatively, a separate UE associated with the vehicle, such as a driver's or passenger's mobile phone, may be used. In the latter case, the separate UE may act as a proxy UE for the vehicle. In either case, the UE (the permanent onboard UE or separate UE associated with the vehicle) may receive the signed document and transmit (e.g., via unicast or broadcast) to other devices in the area using V2X (e.g., using 4G/5G sidelink signaling, over the 5.9 GHz wireless spectrum) to obtain various driving privileges, and this can be applicable for a duration of time defined in the signed document or until a new signed document is issued with changed privileges.

UEs (such as a UE aboard a vehicle as discussed above) may be given special privileges or restrictions depending on which geographical region the vehicle is. Such privileges and restrictions may be obtained from an authority governing the geographical region. A base station (such as a “roadside unit” or “RSU”) may use V2X communication to send or receive privilege information (e.g., contained in a privilege certificate) with the UE. The UE and the vehicle may be configured such that the vehicle abides by behavioral rules set out in the privilege information.

Privileges in a road traffic scenario may be granted for any of a variety of reasons. For example, emergency personnel (e.g., ambulance drivers, paramedics, doctors) or VIPs (e.g., diplomats, government officials, public officials) may need fast and efficient road access in the public interest by avoiding delays. The transport of concrete to a building site may be subject to time limitation to avoid concrete setting. The transport of legal documents may be subject to delivery time constraints. Health and public safety workers may have travel time deadlines. Attendees at important events may need assistance to arrive in time. An airport traveler may need to travel to an airport to catch an imminent flight. Tourists or temporary visitors may enjoy their visit to the region more.

Privileges may grant enhancements to behavioral rules that pertain to traffic rules, which may allow more advantageous traffic rules to apply to UEs and/or vehicles to. Such enhancements may include a variety of modified rules such as usage of special lanes, higher speed limits, shorter wait times at traffic lights, or similar.

Often, the UE moves from one geographical region governed by one authority to another geographical region governed by another authority. For example, the UE may move from one state to another, one county to another, one city to another, one province to another, one country to another, or even one local designated area (e.g., park) to another. In these cases, the UE will need privilege information (e.g., a privilege certificate) from each of the authorities if the user of the UE (e.g., driver of the vehicle) desires to enjoy the privileges. In some cases, the privileges will be revoked if the UE moves to a region governed by another authority for which the UE does not have the privilege certificate.

However, although the geographical regions may be defined territorially and separated by borders or boundaries, there are situations in which the UE must resolve a conflict between rules imposed by two geographical regions. As the UE moves from one authority to another, it may enter an overlapping region where it receives privilege certificates from RSUs of multiple geographical regions. Thus, there is a need to handle the privileges of the UE while moving from one geographical region to another.

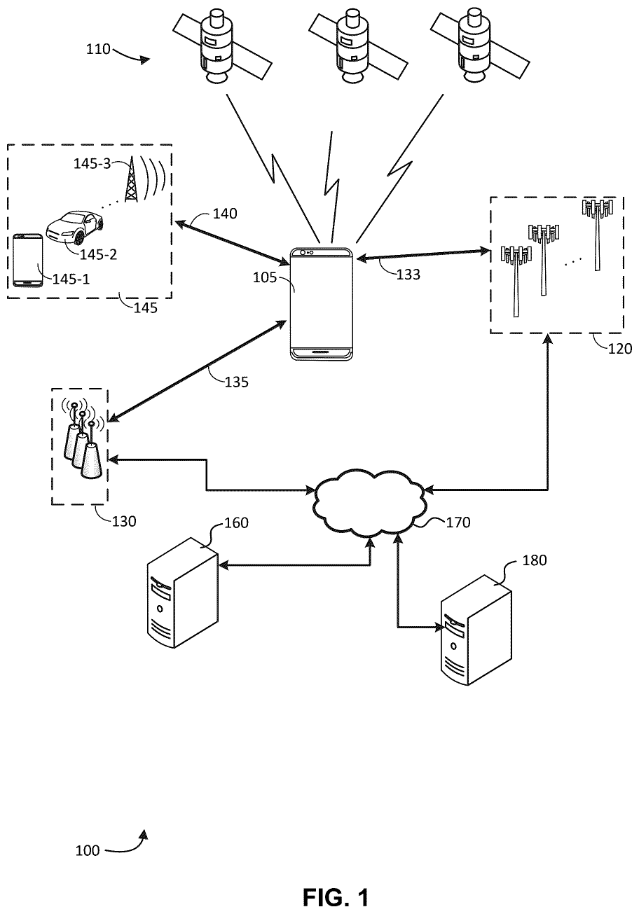

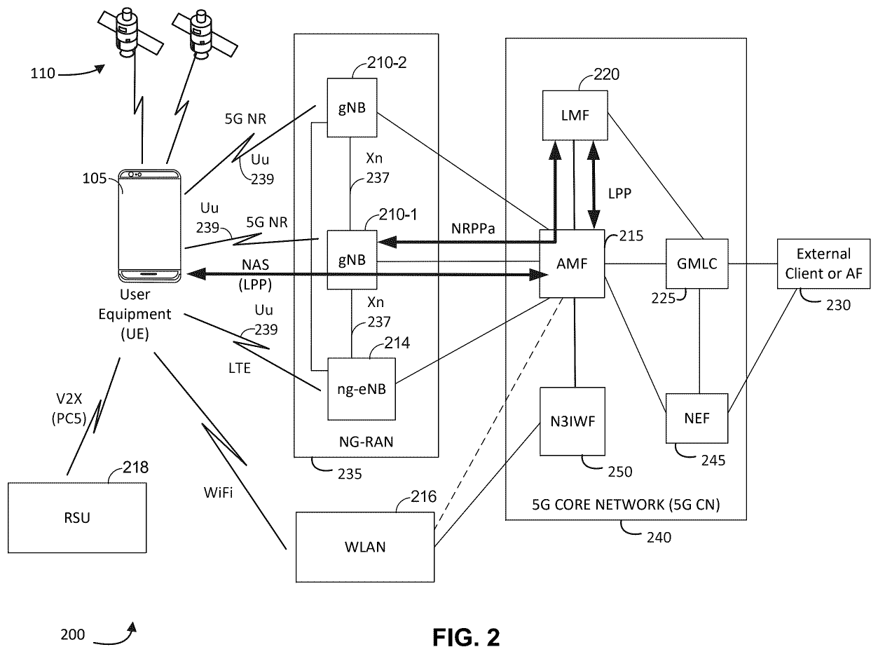

FIG. 1 is a simplified illustration of a communication system 100 in which a UE 105, location server 160, and/or other components of the communication system 100 can use the techniques provided herein for communicating with wireless nodes, e.g., to handle privileges while changing geographic regions, according to an embodiment. The techniques described herein may be implemented by one or more components of the communication system 100. The communication system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the communication system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the communication system 100. Similarly, the communication system 100 may include a larger or smaller number of base stations 120 and/or APs 130 than illustrated in FIG. 1. The illustrated connections that connect the various components in the communication system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the UE 105 in one or more ways. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the UE 105 to perform code-based and/or carrier-based positioning, which can be highly accurate. Additionally or alternatively, satellites 110 may be utilized for Non-Terrestrial Network (NTN)-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the communication system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the UE 105, or a combination thereof. Vehicle 145-2 may be an example of another UE other than UE 105. Wireless signals from mobile devices 145 used for positioning of the UE 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the UE 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular UE 105, the UE 105 for which the position is to be determined may be referred to as the “target UE,” and each of the other mobile devices 145 used may be referred to as an “anchor UE.” For position determination of a target UE, the respective positions of the one or more anchor UEs may be known and/or jointly determined with the target UE. Direct communication between the one or more other mobile devices 145 and UE 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., UE 105) may be facilitated using measurements from one or more anchor devices (e.g., mobile devices 145).

According to some embodiments, such as when the UE 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), vehicle-to-network (V2N) communication between vehicles and a data communication network (e.g., with a base station), and the like. Further, V2X can use any of a variety of wireless RF communication technologies. Cellular V2X (C-V2X), for example, is a form of V2X (specifically, V2N) that uses cellular-based communication such as LTE (4G), NR (5G) and/or other cellular technologies in a direct-communication mode as defined by 3GPP. A component or device on a vehicle, RSU, or other V2X entity that is used to communicate V2X messages is generically referred to as a V2X device, V2X user equipment (UE), or simply a UE, depending on the scenario. Some embodiments described herein may be applicable to any vehicular communication network or system use with the communication system 100 or 200. Such a vehicular communication network may employ communications allocated to the 5.9 GHz wireless spectrum, e.g., dedicated short range (DSRC) or C-V2X.

C-V2X may have different but complementary modes. In some embodiments, a PC5 interface may be used to exchange V2X messages. In some implementations, a PC5 interface may be implemented for direct short-range sidelink communications under 1 kilometer. This may be useful for 5.9-GHz communications independent of cellular networks. In some implementations, a Uu interface may be implemented for longer-range uplink or downlink communications over 1 kilometer. This may be useful for V2N communication, including that which operates in a traditional mobile broadband licensed spectrum.

In some embodiments, the RSU may be a dedicated wireless node device that is capable of V2X communication with a UE. The RSU may be, e.g., a small cell, a femtocell, or other miniature wireless node (e.g., AP or base station), and may have a lower RF power output and/or a lower communication range than other types of base stations, such as a gNB. The RSU as a dedicated unit may be configured to negotiate privileges with a UE (e.g., a vehicle) using V2X, broadcast or send messages using V2X, and/or detect UEs or vehicles.

The UE 105 illustrated in FIG. 1 may correspond to a component or device on a vehicle, RSU, or other V2X entity that is used to communicate V2X messages. Examples of a vehicle include car, truck, watercraft, aircraft, and unmanned aerial vehicle (UAV). In embodiments in which V2X is used, the static communication/positioning device 145-3 (which may correspond with an RSU) and/or the vehicle 145-2, therefore, may communicate with the UE 105 and may be used to determine the position of the UE 105 using techniques similar to those used by base stations 120 and/or APs 130 (e.g., using multiangulation and/or multilateration). In some embodiments, the vehicle may be configured to perform data communication with RSUs. For example, V2X-capable vehicles (“V2X vehicles”) may send and/or receive vehicle information or privilege information (e.g., certificates, registrations) with an RSU using V2X. In some cases, the vehicle may be configured to coordinate maneuvers using V2X. Road safety, traffic management, vehicle management, and the like are some uses for V2X. It can be further noted that mobile devices 145 (which may include V2X devices), base stations 120, and/or APs 130 may be used together (e.g., in a WWAN positioning solution) to determine the position of the UE 105, according to some embodiments. In some embodiments, base stations 120 may include an RSU configured to perform V2X communication with the UE 105, mobile phone 145-1, or vehicle 145-2.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., the location of a base station 120 or AP 130) or some other location such as a location for UE 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example communication system 100 can be implemented using a wireless communication network, such as an LTE-based or 5G NR-based network. FIG. 2 shows a diagram of a 5G NR communication system 200, illustrating an embodiment of a communication system (e.g., communication system 100) implementing 5G NR. The 5G NR communication system 200 may be configured to determine the location of a UE 105 by using access nodes, which may include NR NodeB (gNB) 210-1 and 210-2 (collectively and generically referred to herein as gNBs 210), ng-eNB 214, WLAN 216, and/or RSU 218 to implement one or more positioning or communication methods. The gNBs 210 and/or the ng-eNB 214 may correspond with base stations 120 of FIG. 1, and the WLAN 216 may correspond with one or more access points 130 of FIG. 1. Optionally, the 5G NR communication system 200 additionally may be configured to determine the location of a UE 105 by using an LMF 220 (which may correspond with location server 160) to implement the one or more positioning methods. Here, the 5G NR communication system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network.

The 5G NR communication system 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR communication system 200. Similarly, the 5G NR communication system 200 may include a larger (or smaller) number of satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR communication system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 105. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR communication system 200, such as the LMF 220 and AMF 215.

5G NR communication system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR communication system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node (e.g., gNB 210, ng-eNB 214, or WLAN 216) of a first RAT to an access node of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR communication system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

### Communication of Privileges

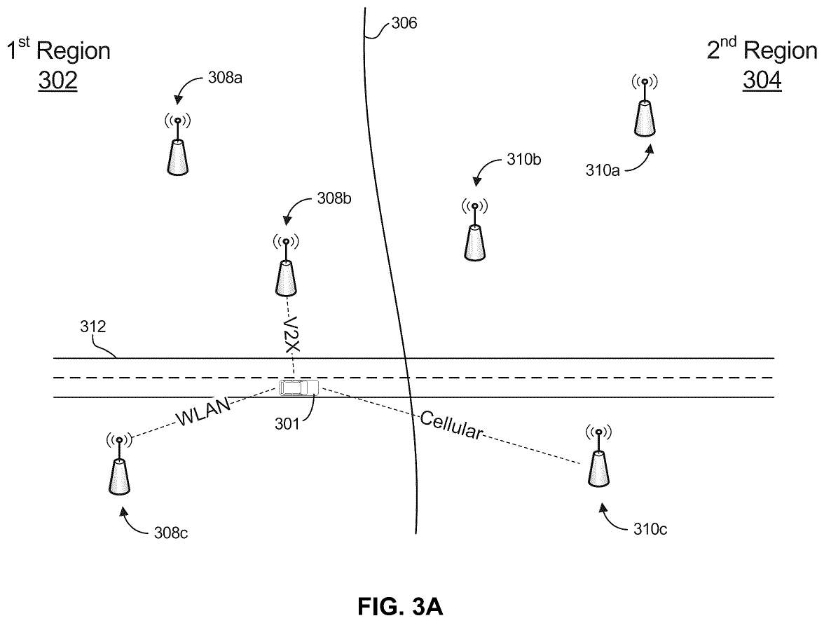

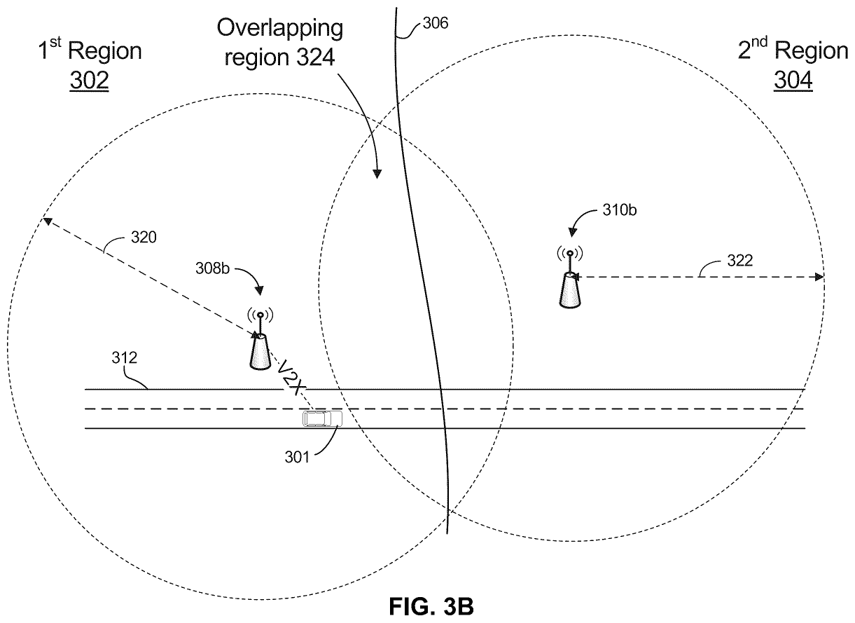

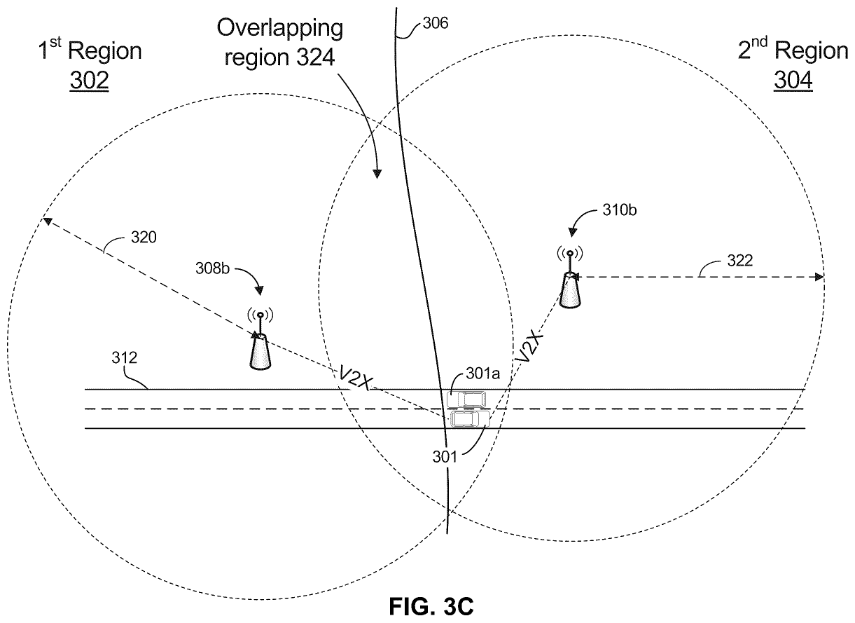

FIG. 3A illustrates an example scenario in which a UE (e.g., vehicle 301) traversing between a first geographical region 302 and a second geographical region 304 communicates with one or more base stations (including RSUs), according to some embodiments. As illustrated, the vehicle may traverse along a road 312 or other path from the first geographical region 302 to the second geographical regions 304, which are separated by a boundary 306. The authorities may have different rules regarding traffic and privileges granted to vehicles.

In some embodiments, UE may be a mobile UE such as vehicle 301, or the UE or UE components may be installed or otherwise incorporated into the vehicle 301, enabling the vehicle 301 to perform wireless communications. In some scenarios, such as that shown in FIG. 3A, the vehicle 301 may be capable of communicating with (among others shown or not shown) base station 308b via V2X, with base station 308c via WLAN, and with base station 310c via cellular protocols. The base station 308b may be referred to as an RSU which is configured to use V2X to communicate directly with the vehicle 301. Each of the base stations 308a-308c and 310a-310c may be configured to communicate using various other data communication methods.

The boundary 306 may be determined territorially. For example, the boundary 306 may be a state line, county line, or other division of territory. The first and second geographical regions 302, 304 may be associated with respective behavioral (e.g., traffic or vehicular) rules governed by respective authorities (e.g., a local government agency, or other regulatory entity). That is, a UE or vehicle may be configured to follow a certain set of behavioral rules while within the first geographical region 302, and follow a different (or in some cases, same) set of behavioral rules while within the second geographical region 304.

In some embodiments, the RSUs may obtain privilege information, e.g., one or more privilege certificates. Privilege information may contain rules, restrictions, priorities, or conditions that grant, deny, or otherwise influence what actions or behaviors are allowed for UEs (e.g., a UE in vehicle 301) within a geographical or territorial area (e.g., first and second geographical regions 302, 304). Privilege information may be determined by the authority of the geographical region (and/or stored at one or more RSUs or servers associated with the region governed by the authority) based on one or more factors, including typical or average level traffic, amount of infrastructure or infrastructure capabilities, number of UEs, number of drivers, past history of behavior associated with a UE (e.g., history of accidents or speeding associated with the vehicle 301 or a driver of vehicle 301, which may subject the UE or the vehicle 301 to a restriction, e.g., reduced speed limit), etc. In some embodiments, the privilege information may be received by the RSU (e.g., from a server or another RSU or base station) prior to the arrival of the UE or upon the arrival of the UE. In some implementations, the privilege information may be static and predetermined to be applicable to UEs regardless of the current conditions. In some implementations, the privilege information may be updated dynamically based on the aforementioned factors at intervals or as the factors change. In some implementations, the privilege information may be determined upon entry or arrival of the UE to a geographical region or to a communication range of a given RSU (e.g., communication range 320 of the first geographical region for RSU 308b, as depicted in FIGS. 3B and 3C).

Examples of privileges and restrictions accorded to a vehicle may include usage of a special lane (e.g., ambulance lane, carpool lane with one person riding the vehicle, exclusive lanes that non-privileged vehicles can access), higher or lower speed limits, or enhanced traffic rules (e.g., traffic light turns green when the UE arrives to skip the wait, or the UE waits a lesser amount of time). This may be beneficial to certain users, such as tourists or temporary visitors, emergency personnel (e.g., ambulance drivers, paramedics, doctors), VIPs (e.g., diplomats, government officials, public officials), or someone who purchases the privilege certificate. In some cases, one or more of the privileges may last a prescribed amount of time. In some cases, one or more of the privileges may terminate upon reaching other condition(s). For instance, the vehicle leaves a designated area (e.g., moves from one geographical region to another), the vehicle goes over speed thresholds, the vehicle is involved in a traffic violation, or the like.

In some cases, vehicles can be given different types or different levels of privileges based on their requirement (e.g., whether it is an ambulance truck, police car, firetruck, or other emergency vehicle requiring priority access to an emergency lane), type of vehicle (e.g., motorcycle, sedan, or UAV), or upon a request to the specific authority or authorities that govern the geographical region via, e.g., the RSU using V2X messages.

FIG. 3B illustrates a view of the UE (e.g., vehicle 301) within a coverage area of an RSU 308b within the first geographical region, according to some embodiments. In some embodiments, the RSU 308a within the first geographical region 302 may have an associated communication range 320, and another RSU 310b within the second geographical region 304 may have an associated communication range 322. The RSUs 308a and 310b may be configured to communicate with other UEs, such as the vehicle 301, using V2X within the respective communication ranges 320 or 322.

In FIG. 3B, the vehicle 301 is within the communication range 320 of the first geographical region 302. The vehicle 301 is not within or has not moved into other communication ranges. In some embodiments, RSU 308b has already received privilege information (e.g., a privilege certificate) from a server, prior to or upon entry of the vehicle 301 into the communication range 320. In some scenarios, RSU 308b may send privilege information (e.g., the privilege certificate) to the vehicle 301 using V2X, while the vehicle 301 is within the communication range 320. In some scenarios, another RSU within the first geographical region 302 may have already sent the privilege information applicable to the first geographical region 302 to the vehicle 301, e.g., while the vehicle 301 was in other parts of the first geographical region 302. RSUs 308b and 310b may be “edge” nodes (relative to the vehicle 301) of the first and second geographical regions 302 and 304, respectively, where these RSUs are the most proximate to the boundary 306 and the road 312.

Thus, the vehicle 301 may possess certain privileges indicated by the privilege certificate, and may follow rules and conditions set forth by the privilege information governing the first geographical region 302. While within the first geographical region 302, the vehicle 301 may, for example, use a carpool lane as a one-person vehicle, or use an emergency lane reserved for ambulances and other types of vehicles having priority over others. As another example, traffic lights may turn or remain green when the vehicle 301 approaches a traffic signal, which may be detectable using, e.g., visual sensors and/or a V2X message to an RSU disposed ahead of the traffic signal.

However, in some cases, the vehicle 301 may be under the jurisdiction of both the first and second geographical regions 302, 304, which requires resolution of a conflict as to which privileges and restrictions the vehicle 301 should follow. Such cases may arise when base stations (e.g., base stations 308a-308c within the first geographical region 302, and base stations 310a-310c within the second geographical region 304) have communication ranges that extends beyond the boundary 306, where the boundary 306 is purely territorially determined. The vehicle 301 may be within range of both base stations 308b and 310b simultaneously, for instance, when it is within an overlapping region 324 near the boundary 306 separating the first geographical region 302 and the second geographical region 304.

FIG. 3C illustrates a view of the UE (e.g., vehicle 301) within the overlapping region 324 near the boundary 306 separating the first geographical region 302 and the second geographical region 304, according to some embodiments. The overlapping region 324 is associated with both the first and second geographical regions 302, 304. Depending on the scenario, the overlapping region 324 may be small, on the order of square meters, or larger, on the order of square kilometers. The change in jurisdiction by the UE may last a significant length of time, and hence, involve a communication between the UE and an RSU of the new jurisdiction (e.g., RSU 310b) since the privileges allowed in the two jurisdictions of the first and second geographical regions 302, 304 may be different.

The UE (e.g., vehicle 301) may receive privilege information from the first RSU (e.g., RSU 310b) of the second geographical region 304, which may enable the vehicle to follow a new set of privileges and restrictions. In some implementations, the RSU 310b may send the privilege information (e.g., as a privilege certificate) as soon as the vehicle 301 enters a communication range 322 of the RSU 310b. In some implementations, the RSU 310b may send the privilege information after the vehicle 301 is within a certain distance within the communication range 322, which may indicate that the vehicle 301 is physically within the geographic region the RSU 310b is in, or indicate a likelihood of it.

As an example, an old jurisdiction (e.g., governing the first geographical region 302) may allow a speed limit of 50 miles per hour (MPH), and a new jurisdiction (e.g., governing the second geographical region 304 the vehicle 301 is entering) may mandate the speed limit to 30 MPH. As another example, the old jurisdiction may allow the vehicle 301 to turn red traffic lights to green as or when it approaches the traffic light, but in the new jurisdiction, there may be a mandate to turn traffic lights to green only after a minimum time period, or to limit remaining time for a green light to a maximum time period (e.g., 10 seconds).

In some embodiments, the privileges are handled by the RSUs within each geographical region, and the overlapping region 324 may be governed by the last RSU that was within range of the vehicle 301. In the case of FIG. 3C, when the vehicle 301 enters the overlapping region 324 from the first geographical region 302 toward the second geographical region 304, the vehicle 301 may retain the privilege information (e.g., the privilege certificate) issued by the authority of the first geographical region 302. The vehicle 301 may continue to operate under the privileges and restrictions of the first geographical region 302, despite the vehicle 301 being physically within the second geographical region 304. In another scenario, if a vehicle 301a operating under the jurisdiction of the second geographical region 304 were moving from the second geographical region 304 toward the first geographical region 302, and were within the overlapping region 324, the vehicle 301a would continue to operate under the rules of the second geographical region 304 (received from, e.g., RSU 310b) despite being within range of the RSU 308b and receiving privilege information associated with the first geographical region 302.

In some embodiments, once the UE (e.g., of the vehicle 301) exits the communication range 320 of the RSU 308b of the first geographical region 302, the new geographical region (e.g., the second geographical region 304) would control the privileges and restrictions of the UE aboard the vehicle 301. In some implementations, a time period may be set before some or all of the new privileges and restrictions must be followed. For example, if the old speed limit was 50 MPH and the new speed limit is 30 MPH, there may be a time delay to allow the vehicle 301 to comply with the new speed limit. In some implementations, a user interface associated with the vehicle 301 or the UE installed in the vehicle 301 may indicate the new privileges and restrictions, as well as any times, durations, or countdowns before new privileges and restrictions must be followed.

In other words, if the vehicle 301 has moved from the first geographical region 302 into the overlapping region 324, rules of the first authority may be applied to the vehicle 301 until the vehicle 301 moves completely to the new authority (and vice versa). The region or signal range covered by these two edge RSUs is a conflict zone, which in some embodiments may be governed by the edge RSU of the first geographical region 302 while exiting the first geographical region 302. The rules and privileges of the first geographical region 302 would apply until the UE leaves the range of the edge RSU of the first geographical region 302. While the edge RSU of the second geographical region 304 can provide the certificate to the UE while the UE is in the overlapping region 324, the privileges and restrictions of the second geographical region 304 would not apply until the UE has left the jurisdiction of the first authority.

However, in other privilege negotiation schemes, entry into the overlapping region 324 and receipt of privilege information associated with the new authority (e.g., second geographical region 304) may cause application of the privileges and restrictions of the authority that the UE is entering (e.g., second geographical region 304) instead of those of the authority (e.g., first geographical region 302) that the UE is exiting.

In some embodiments, no new privilege information may be received upon entry into a geographical region (e.g., 302 or 304) or into a communication range (e.g., 320 or 322). That is, there may not be any special privileges or limitations under some jurisdictions.

In some embodiments, a privilege certificate may be purchased from the issuing authority. In some cases, a user of the UE or vehicle may purchase the issuing authority when desired in order to access additional privileges (e.g., usage of an emergency lane). In some cases, the purchase may be automatic upon entry. Costs may be different in different authorities. In some cases, the type of privileges and the amount of privileges granted may be based on the cost. For example, usage of an emergency lane may have a different cost than ensuring a low wait time for traffic light. When two or more vehicles or UEs have competing privileges, the higher-paying vehicle or UE may be granted a higher privilege level. For instance, at an intersection, a first vehicle that has paid more than a second vehicle may receive the green light while the second vehicle is forced to wait at least until the first vehicle has traversed the intersection. However, in shared resources such as exclusive lanes, every vehicle may possess the same privilege to use an exclusive lane.

In some embodiments, upon entry of the vehicle 301 to the new geographical region and outside the communication range of the prior geographical region (e.g., communication range 320), the first RSU of the new geographical region (e.g., RSU 310b) may redetermine priority levels associated with the vehicles within the range of the RSU. Some UEs or vehicles may be given more or less privileges and restrictions than others.

It will be appreciated that while the above description is in the context of a vehicle (as a UE) and/or a UE installed on the vehicle, the above description may be equally applicable to other types of UEs. For example, the vehicle 301 in FIGS. 3A-3C may be a phone, a drone or UAV, or a pedestrian walking between two regions such as parks.

Advantageously, using the initially obtained privileges (e.g., associated with first geographical region 302) within the overlapping region 324 as described above may simplify the process of detecting a new cell (e.g., RSU 310b) while signal from the new cell may be weaker at the entry point or edge of the overlapping region 324. In some scenarios, this approach may also avoid frequent “ping-pong” switching connections between, e.g., RSUs 308b and 310b, if the path (e.g., road 312) between them were to be not a straight line, but with curves, blockages, etc. Moreover, this approach may also add consistency such that all the UEs and/or vehicles follow the same rules within the overlapping region 324. Without such consistency, different UEs using privileges associated with different authorities may result in a deadlock.

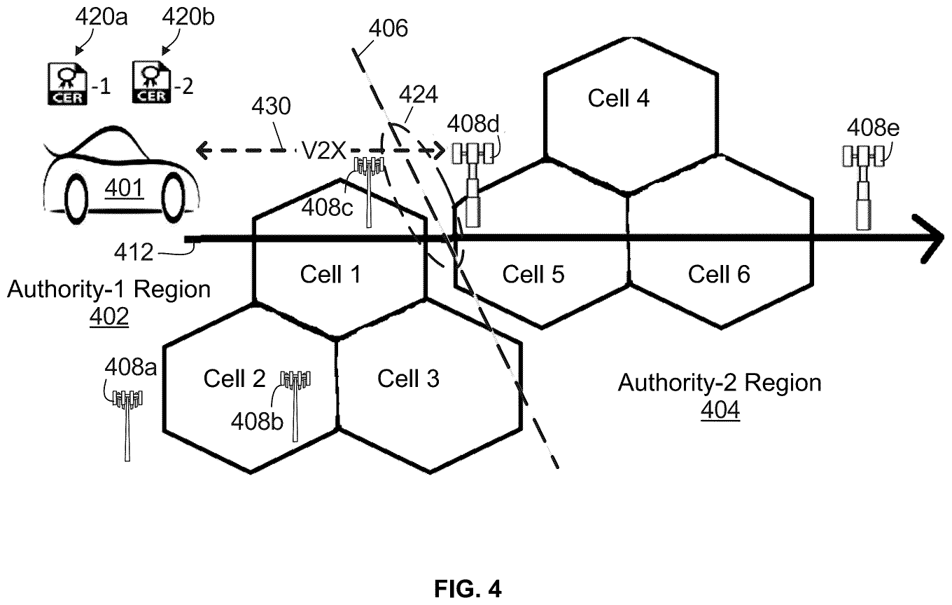

FIG. 4 illustrates another example scenario in which a UE (e.g., vehicle 401) traversing between a first geographical region 402 and a second geographical region 404 along a path 412 communicates with one or more base stations (including RSUs), according to some embodiments. In some embodiments, the first geographical region 402 may be governed by at least one respective authority (e.g., a government entity or other regulatory entity), and the second geographical region 404 may be governed by at least one respective authority as well. The first geographical region 402 may include one or more cell coverage areas, e.g., Cell-1, Cell-2, Cell-3. The second geographical region 404 may include one or more cell coverage areas, e.g., Cell-4, Cell-5, Cell-6. In this scenario, the geographical regions 402, 404 may be defined by the cell coverage areas, rather than terrestrial boundaries, such as boundary 306. In some implementations, a cell coverage area may be based on a communication range of a cellular base station. In some implementations, a cell coverage area may be based on a communication range of an RSU. As shown in FIG. 4, various RSUs may be positioned within a geographical region. For example, RSU 408d may be configured to cover cell coverage area Cell-5. A general boundary 406 may exist nonetheless between the first geographical region 402 and the second geographical region 406.

UE sharing privilege certificates to RSUs: In some cases, privileges and restrictions may be bound to or associated with a UE (e.g., the vehicle 401). For example, the vehicle 401 may possess or otherwise store one or more privilege certificates (e.g., 420a, 420b) at a storage device or a UE installed in the vehicle 401. In some cases, the privilege certificate(s) may have been obtained as a default setting originating from the UE itself. In some cases, the privilege certificate(s) may have been received while in the first geographical region 402, e.g., from an RSU (e.g., RSU 408a) using a V2X message. The privilege certificate(s) may indicate privileges and restrictions for the UE or the vehicle 401 while within certain geographical regions. For example, the vehicle 401 may access a special lane within the first geographical region 402 only. In some cases, the privileges and restrictions may be applicable to a specific extent in a specific cell coverage area. For example, the speed limit may be 50 MPH while in Cell-2 but 30 MPH while in Cell-1, while close to the boundary 406 between geographical regions. As another example, the certificate(s) may indicate that the vehicle 401 may have shorter wait times or access to a carpool lane while in Cell-3 but not in Cell-1 or Cell-2.

In some implementations, multiple privilege certificates 420a, 420b may indicate respective sets of privileges or restrictions, or indicate privileges or restrictions respectively applicable to different authorities, cells, or geographical regions. As an illustrative example, a first privilege certificate 420a may grant the vehicle 401 a privilege of using an emergency lane in the first geographical region 402 but not in the second geographical region 404, and a second privilege certificate 420b may control the speed at which the vehicle 401 may drive (e.g., 50 MPH in the first geographical region 402 and 30 MPH in the second geographical region 404). In a different example, the first privilege certificate 420a may correspond to one authority and cells associated with it (e.g., Cell-1, Cell-2, Cell-3), and the second privilege certificate 420b may correspond to another authority and cells associated with it (e.g., Cell-4, Cell-5, Cell-6). The first privilege certificate 420a may grant the vehicle 401 use of various privileges or impose limitations within a particular location (e.g., the first geographical region 402), while the second privilege certificate 420b may grant privileges or restrict actions of the vehicle 401 within a different location (e.g., second geographical region 404).

In some embodiments, the UE (e.g., vehicle 401) may communicate its privilege certificate(s) with one or more RSUs. The RSUs may authenticate or acknowledge the UE so that the UE can enjoy the benefits of privileges granted by the certificate(s) within the authority associated with the RSU (e.g., cell coverage area, geographical region). In order to share the certificate with the appropriate RSU(s), the UE should be aware of the authority where it is present or where it is entering into. The UE may determine its location (and hence the authority and geographical region) based on the presence of one or more base stations located in the geographical region, or using positioning systems such as GNSS. In some implementations, a UE may receive information regarding nearby neighboring cells (e.g., determine locations of neighboring cells while in Cell-3). In some implementations, the UE may receive identifiers from base stations and RSUs (e.g., via beacons) which indicate the cells that they are in. If the UE receives an identifier for Cell-3, the UE may determine that it is within Cell-3, based on which the UE may determine that neighboring cells include Cell-1, Cell-2, and Cell-5, the last of which is in another geographical region (second geographical region 404) managed by a different authority than that of Cell-3. This may indicate to the UE a possibility that there might be a change in the cell coverage area or authority (e.g., as the vehicle 401 moves across the boundary 406). The UE may send its certificate(s) to one or more RSUs that correspond to the neighboring cells, e.g., RSU 408b in Cell-2, RSU 408c in Cell-1, and/or RSU 408d in Cell-5. By sending the certificate(s) before the UE physically moves into the cell coverage area or geographical region (e.g., using a V2X message over a PC5 interface 430), the UE can continue operating under the rules of the certificate(s) without initiating the transmission for the first time during a handover between cell coverage areas. In some implementations, the UE may send the certificate(s) to one or more RSUs that are closest to the UE.

In some scenarios where a handover occurs, the UE may cross a border (e.g., boundary 406) between geographical regions 402, 404, where different privileges may be given to the UE under the new authority without the certificate. For example, the vehicle 401 may drive from the first geographical region 402 to the second geographical region 404, each of which is associated with different default rules. By default, the second geographical region 404 may limit vehicle speed to 30 MPH, without a privilege certificate, for instance. However, as the UE moves from one authority to another, it may enter an overlapping region 424 where communication ranges of one RSU (e.g., 408c) in one geographical region (e.g., 402) and another RSU (e.g., 408d) in another geographical region (e.g., 404) intersect, where the UE (e.g., vehicle 401) must resolve a conflict between rules imposed by the two geographical regions.

In some embodiments, in the overlapping region 424, the UE may retain the privileges and restrictions granted by the privilege certificate(s) and applicable within the existing authority (e.g., first geographical region 402) until the UE has completed the handover to an RSU in another authority (e.g., second geographical region 404). Once the UE is outside of the communication range of the last RSU (e.g., 408c) of the existing authority, the UE may provide privilege certificate(s) to the RSU (e.g., 408d) of the new authority. For example, if the vehicle 401 enters the second geographical region 404 and is completely past the overlapping region 424, the UE (e.g., aboard the vehicle 401) may send one or more privilege certificate(s) 420a, 420b via V2X messages over a PC5 interface.

RSU handling privileges: In some embodiments, once the UE performs a handover to a cell coverage area of another authority, the UE can receive a new privilege certificate of the new authority to exercise the privileges granted by the new privilege certificate. In some embodiments, in the overlapping region 424, the privilege certificate of the previous authority (e.g., of the first geographical region 402) may apply until a cell reselection or handover to the new authority (e.g., of the second geographical region 404) takes place.

Fallback processes in failure scenarios: However, in some scenarios, there is a chance that bandwidth constraints or network congestion causes a message exchange (e.g., V2X message between a UE and an RSU) to be unsuccessful. Interference with other UEs, vehicles, or networks may prevent the successful transmission, receipt, and/or acknowledgment of the message. In such scenarios, in some implementations, the UE may configure the message such that the priority of the message is increased, which may allow the UE to reduce the sensing window, forcing the message to be sent to the RSU sooner. In some implementations, the UE may allocate more resources (subchannels, subcarriers, symbols, resource elements, resource blocks, etc.) for the message. In some implementations, the UE may perform multiple transmissions to increase the chances of a successful communication of the message to the RSU. The delay period between transmission attempts may be reduced. In some implementations, the UE may attempt to send the message to other base stations or RSUs that have been detected and/or identified (e.g., via beacons originating from the base stations or RSUs) even if the other base stations or RSUs are at a greater distance than the attempted RSU.

In the case that communication between the UE and the RSU is not successful, the UE may continue attempting the communication using one or more of the above fallback processes to overcome congestion (increase message priority, allocate more resources, perform multiple transmissions, attempt other RSUs). In some embodiments, while the UE attempts to successfully send the message to an RSU, the UE may continue to operate in a non-privileged or low-privilege state or mode until the communication is successful. In some implementations, a non-privileged state of operation of the UE may be a normal operation without any enhanced privileges. That is, any normal restrictions and privileges set by an authority (posted speed limits, no usage of carpool unless two or more riders in a vehicle, bandwidth throttling, etc.) may apply to the UE. In some implementations, a non-privileged state of operation of the UE may be in a lower priority state compared to other UEs that have been able to send privilege certificates to the authority (e.g., via an RSU). Restrictions to the UE may be imposed. For example, cellular communication mode may be limited to 3G, the speed limit for a vehicle may be lowered to 25 MPH from a normal limit of 40 MPH, or carpool lanes may be closed regardless of the number of riders in a vehicle.

In some scenarios, the UE may continue to pass a RSU (e.g., RSU 408d) with which the UE could not establish communication and leave the RSU's communication range while in the non-privileged state. As the UE continues to move away from RSU 408d, the UE may continue to attempt to send privilege certificates to the new authority (e.g., the second geographical region 404) and attempt communication with the next available RSU (e.g., RSU 408e). The UE may stay in the non-privileged state until the communication with one of the RSU's is successful.

To illustrate an example scenario, the UE (e.g., vehicle 401) may traverse along the path 412 that extends across multiple authorities. To enact any changes according to the different rules that the UE should follow, the UE may share (send) a privilege certificate to new RSUs within range. For example, as the vehicle 401 crosses over from Cell-1 to Cell-5 (e.g., while within communication range of RSU 408d of Cell-5, which may be within the overlapping region 424 created by an overlap of communication ranges of RSUs 408c and 408d), the UE may send one or more privilege certificates corresponding to the new authority (e.g., associated with the second geographical region 404) to the RSU 408d. In some embodiments, a V2X message may be used, using a PC5 interface 430 of the UE. If the communication between the UE and the RSU 408d fails and the UE is moving close to RSU 408e, the UE may implement one or more of the aforementioned fallback processes to overcome congestion. This may include attempting to share the privilege certificate(s) corresponding to the new authority to RSU 408e, which is past RSU 408d. In the meantime, the UE may operate in a non-privileged state. If communication were to fail between the UE and RSU 408e as well, the UE may continue with a non-privileged or a default-privilege state of operation until successful communication with an upcoming RSU beyond RSU 408e.

The above approach of having the UE communicate the privilege information to the network entity (e.g., RSU 408d) may be advantageous because the UE need not depend on the network to obtain the privilege information. The UE may obtain a privilege certificate prior to entering a new authority and share it with the authority once the UE enters the geographical region of the new authority. There is also reduced potential for mishandling of the privilege information, e.g., from impostors, hackers, or other malicious actors. In some implementations, the receiving RSU (e.g., 408d) may check the integrity of the privilege information or check for duplicate or unauthorized privileges.

### Methods

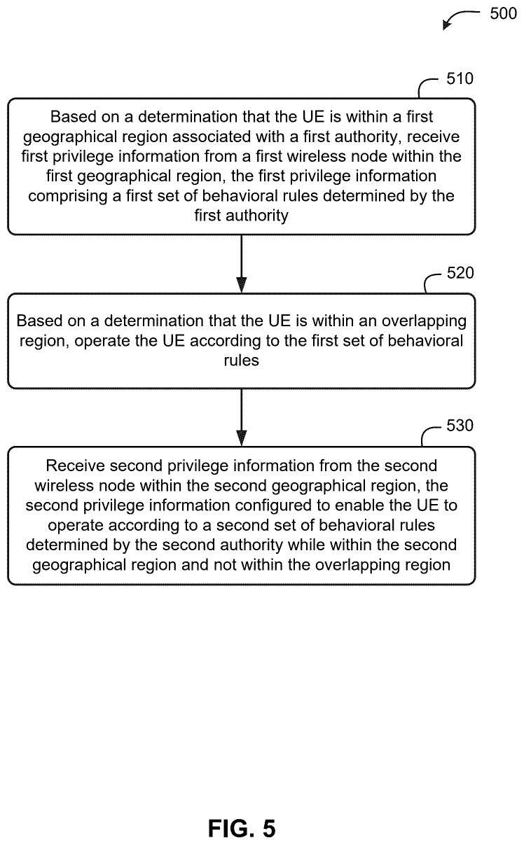

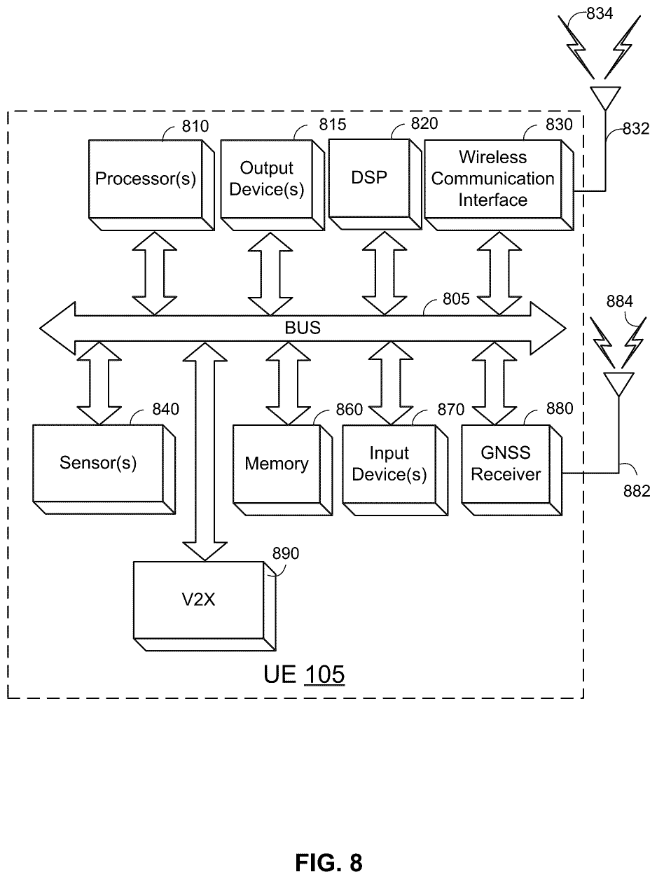

FIG. 5 is a flow diagram of a method 500 of receiving privileges at a user equipment (UE), according to some embodiments. Means for performing the functionality illustrated in one or more of the blocks shown in FIG. 5 may be performed by hardware and/or software components of a UE, or of a computer-readable apparatus including a storage medium storing computer-readable and/or computer-executable instructions that are configured to, when executed by at least one processor apparatus, cause the at least one processor apparatus or a computerized apparatus (e.g., the UE) to perform the operations. In some embodiments, the UE may include V2X capabilities. Example components of a UE are illustrated in FIG. 8, which is described in more detail below.

It should also be noted that the operations of the method 500 may be performed in any suitable order, not necessarily the order depicted in FIG. 5. Further, the method 500 may include additional or fewer operations than those depicted in FIG. 5 to receive privileges.

At block 510, the method 500 may include, based on a determination that the UE is within a first geographical region associated with a first authority, receiving first privilege information from a first wireless node within the first geographical region, the first privilege information comprising a first set of behavioral rules determined by the first authority. In some embodiments, the UE may be a mobile UE. In some implementations, the UE may be co-located with a vehicle (e.g., temporarily or permanently on board the vehicle). In some implementations, the UE may be a vehicle.

The first geographical region 302 may be an example of the first geographical region. The second geographical region 304 may be an example of the second geographical region. The vehicle 301 or 301a may be an example of the UE.

In some embodiments, the first privilege information may be contained in a first privilege certificate that defines one or more locations at which the first set of behavioral rules applies to the vehicle. In some cases, the first set of behavioral rules may include a speed limit for the vehicle, usage of one or more special lanes (e.g., emergency lane, carpool lane) by the vehicle, a waiting time for a traffic light, or a combination thereof. Other behavioral rules may be implemented as well. In some embodiments, the first authority and the second authority may be associated with respective first and second regulatory entities governing the first geographical region and the second geographical region.

In some embodiments, the first wireless node may include a first roadside unit (RSU) configured to transmit or receive data with the UE via vehicle-to-everything (V2X) communication, and the second wireless node may include a second RSU configured to transmit or receive data with the UE via V2X communication. The RSU 308b may be an example of the first wireless node in one scenario (e.g., vehicle 301a moving from first geographical region 302 to second geographical region 304). The RSU 310b may be an example of the first wireless node in another scenario (e.g., vehicle 301a moving from second geographical region 304 to first geographical region 302).

In some embodiments, prior to the determination that the UE is within the overlapping region, the UE may operate according to the first set of behavioral rules while within the first geographical region.

Means for performing functionality at block 510 may comprise a wireless communication interface 830, wireless communication antenna(s) 832, and/or other components of a UE, as illustrated in FIG. 8.

At block 520, the method 500 may include, based on a determination that the UE is within an overlapping region, operating the UE according to the first set of behavioral rules. In some embodiments, the overlapping region may be within a communication range of the first wireless node within the first geographical region and a communication range of a second wireless node within a second geographical region associated with a second authority. Overlapping region 324 may be an example of the overlapping region. RSU 310b may be an example of the second wireless node.

In some scenarios, the UE may have been operating according to the first set of behavioral rules already while within the first geographical region, and may continue to operate using the same rules within a zone of contention between two geographical regions (e.g., within the overlapping region).

Means for performing functionality at block 520 may comprise processor(s) 810 and/or other components of a UE, as illustrated in FIG. 8.

At block 530, the method 500 may include receiving second privilege information from the second wireless node within the second geographical region, the second privilege information configured to enable the UE to operate according to a second set of behavioral rules determined by the second authority while within the second geographical region and not within the overlapping region.

In some embodiments, the receiving of the second privilege information may be based on a determination that the UE is within the second geographical region. The UE may still be within a communication range of the first wireless node while being within the second geographical region. In some embodiments, the receiving of the second privilege information may be prior to a determination that the UE is within the second geographical region. For example, a vehicle may still be within the overlapping region of the first wireless node and the second wireless node but geographically in the first geographical region before crossing a boundary (e.g., boundary 306) separating the first and second geographical regions.

Means for performing functionality at block 530 may comprise a wireless communication interface 830, wireless communication antenna(s) 832, and/or other components of a UE, as illustrated in FIG. 8.

In some embodiments, based on a determination that the UE is within the second geographical region and not within the overlapping region, the method 500 may further include switching, from the operation of the UE according to the first set of behavioral rules, to an operation of the UE that is based on the second set of behavioral rules. In some implementations, the second set of behavioral rules may be different from the first set of behavioral rules.

In this manner described by method 500, a UE (e.g., a vehicle) may retain the privileges received by an initial authority (e.g., via an RSU of that authority) until the UE is entirely within another authority. However, the UE may also provide privilege information to the authority.

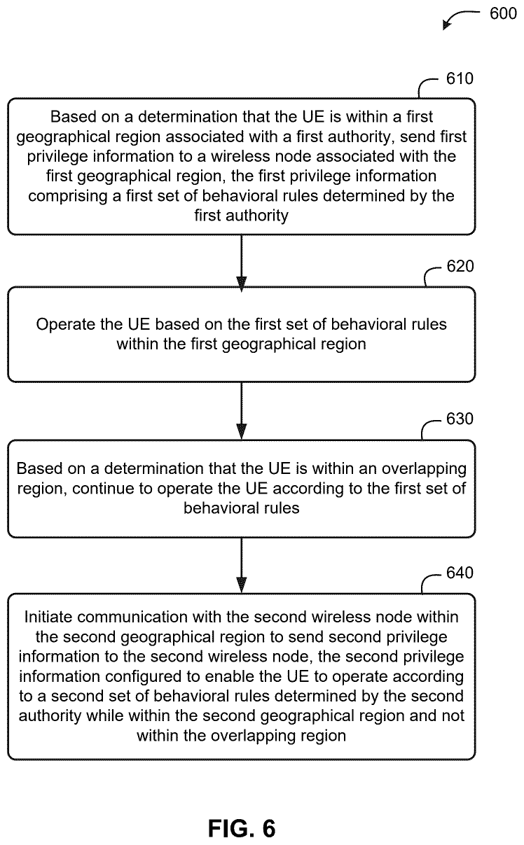

FIG. 6 is a flow diagram of a method 600 of sending privilege information with a UE, according to some embodiments. Means for performing the functionality illustrated in one or more of the blocks shown in FIG. 6 may be performed by hardware and/or software components of a UE, or of a computer-readable apparatus including a storage medium storing computer-readable and/or computer-executable instructions that are configured to, when executed by at least one processor apparatus, cause the at least one processor apparatus or a computerized apparatus (e.g., the UE) to perform the operations. In some embodiments, the UE may include V2X capabilities. Example components of a UE are illustrated in FIG. 8, which is described in more detail below.

It should also be noted that the operations of the method 600 may be performed in any suitable order, not necessarily the order depicted in FIG. 6. Further, the method 600 may include additional or fewer operations than those depicted in FIG. 6 to send privilege information.

At block 610, the method 600 may include, based on a determination that the UE is within a first geographical region associated with a first authority, sending first privilege information to a wireless node associated with the first geographical region, the first privilege information comprising a first set of behavioral rules determined by the first authority. In some embodiments, the UE may be a mobile UE. In some implementations, the UE may be co-located with a vehicle (e.g., temporarily or permanently on board the vehicle). In some implementations, the UE may be a vehicle.

The first geographical region 402 may be an example of the first geographical region. The second geographical region 404 may be an example of the second geographical region. The vehicle 401 may be an example of the UE.

In some embodiments, the first privilege information may be contained in a first privilege certificate that defines one or more locations at which the first set of behavioral rules applies to the vehicle. In some cases, the first set of behavioral rules may include a speed limit for the vehicle, usage of one or more special lanes (e.g., emergency lane, carpool lane) by the vehicle, a waiting time for a traffic light, or a combination thereof. Other behavioral rules may be implemented as well. In some embodiments, the first authority and the second authority may be associated with respective first and second regulatory entities governing the first geographical region and the second geographical region.

In some embodiments, the first wireless node may include a first RSU configured to transmit or receive data with the UE via V2X communication, and the second wireless node may include a second RSU configured to transmit or receive data with the UE via V2X communication. The RSU 408c may be an example of the first wireless node in one scenario (e.g., vehicle 401 moving from first geographical region 402 to second geographical region 404).

In some embodiments, prior to the determination that the UE is within the overlapping region, the UE may operate according to the first set of behavioral rules while within the first geographical region.

Means for performing functionality at block 610 may comprise a wireless communication interface 830, wireless communication antenna(s) 832, and/or other components of a UE, as illustrated in FIG. 8.

At block 620, the method 600 may include operating the UE based on the first set of behavioral rules within the first geographical region. Depending on the rule(s), the UE (e.g., the vehicle) may operate under enhanced behavioral rules, such as a higher speed limit, access to a special lane, lower waiting time at traffic lights, and so on.

Means for performing functionality at block 620 may comprise processor(s) 810 and/or other components of a UE, as illustrated in FIG. 8.

At block 630, the method 600 may include, based on a determination that the UE is within an overlapping region, operating the UE according to the first set of behavioral rules. In some embodiments, the overlapping region may be within a communication range of the first wireless node within the first geographical region and a communication range of a second wireless node within a second geographical region associated with a second authority. Overlapping region 324 may be an example of the overlapping region.

In some scenarios, the UE may have been operating according to the first set of behavioral rules already while within the first geographical region, and may continue to operate using the same rules within a zone of contention between two geographical regions (e.g., within the overlapping region).

Means for performing functionality at block 630 may comprise processor(s) 810 and/or other components of a UE, as illustrated in FIG. 8.

At block 640, the method 600 may include initiating communication with the second wireless node within the second geographical region to send second privilege information to the second wireless node within the second geographical region, the second privilege information configured to enable the UE to operate according to a second set of behavioral rules determined by the second authority while within the second geographical region and not within the overlapping region. RSU 408d may be an example of the second wireless node.

In some embodiments, the sending of the second privilege information to the second wireless node may be based on a determination that the UE is within the second geographical region and not within the overlapping region. The UE may still be within a communication range of the first wireless node while being within the second geographical region. In some embodiments, the receiving of the second privilege information may be prior to a determination that the UE is within the second geographical region. For example, a vehicle may still be within the overlapping region of the first wireless node and the second wireless node but geographically in the first geographical region before crossing a boundary (e.g., boundary 306) separating the first and second geographical regions.

Means for performing functionality at block 640 may comprise a wireless communication interface 830, wireless communication antenna(s) 832, and/or other components of a UE, as illustrated in FIG. 8.

In some embodiments, based on a determination that that the UE is within the second geographical region and not within the overlapping region, the method 500 may further include switching, from the operation of the UE according to the first set of behavioral rules, to an operation of the UE that is based on the second set of behavioral rules. In some implementations, the second set of behavioral rules may be different from the first set of behavioral rules.

In some scenarios, communication with the second wireless node may be unsuccessful. This may happen for one or more reasons, including network congestion, bandwidth constraints, interference, and so on. In some embodiments, to mitigate these scenarios, the UE may be configured to determine a failure of the initiated communication with the second wireless node, and based on this determination, implement one or more fallback processes to send the second privilege information. In various implementations, the one or more fallback processes may include an increase of message priority with the second wireless node, allocation of more resources for the communication with the second wireless node, initiation of multiple communication with the second wireless node, initiation of communication with a third wireless node (e.g., RSU 408e), or a combination thereof. During the one or more fallback processes, the UE may operate according to a third set of behavioral rules. The third set of behavioral rules may be according to default privileges or a state of no privileges, and may overlap partially or wholly with the first or second set of behavioral rules.

In this manner described by method 600, a UE (e.g., a vehicle) may send privilege information to an authority (e.g., via an RSU of that authority).

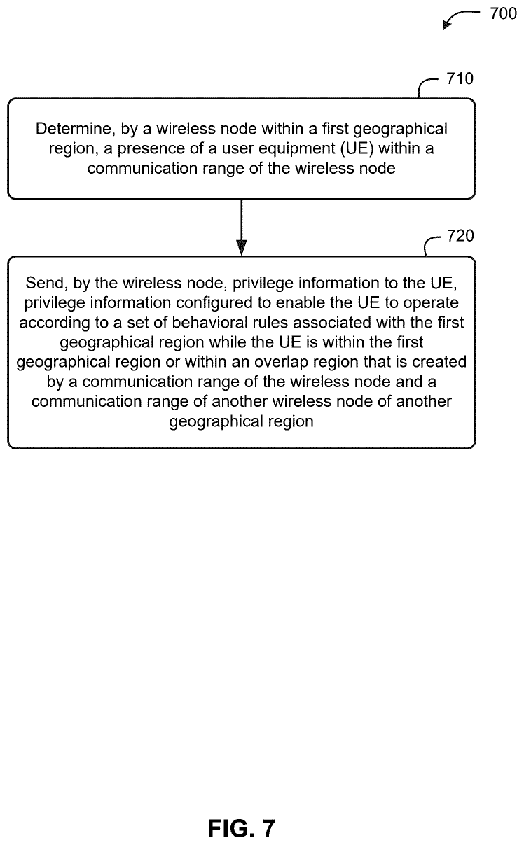

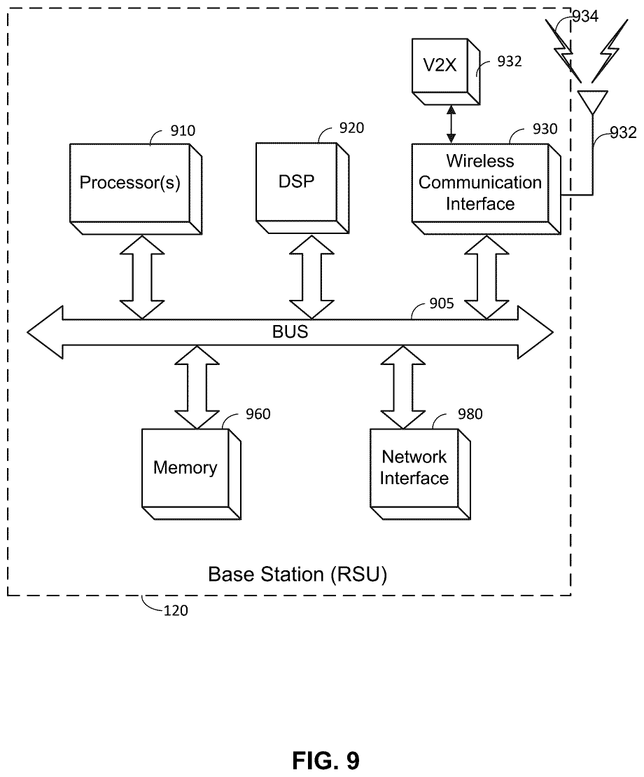

FIG. 7 is a flow diagram of a method 700 of granting privileges to a UE, according to some embodiments. Means for performing the functionality illustrated in one or more of the blocks shown in FIG. 7 may be performed by hardware and/or software components of a base station (e.g., RSU), or of a computer-readable apparatus including a storage medium storing computer-readable and/or computer-executable instructions that are configured to, when executed by at least one processor apparatus, cause the at least one processor apparatus or a computerized apparatus (e.g., the RSU) to perform the operations. In some embodiments, the RSU may include V2X capabilities. Example components of a base station or an RSU are illustrated in FIG. 9, which is described in more detail below.

It should also be noted that the operations of the method 900 may be performed in any suitable order, not necessarily the order depicted in FIG. 9. Further, the method 600 may include additional or fewer operations than those depicted in FIG. 9 to grant privileges.

At block 710, the method 700 may include determining, by a wireless node within a first geographical region, a presence of a user equipment (UE) within a communication range of the wireless node. In some embodiments, the UE may be a mobile UE. In some implementations, the UE may be co-located with a vehicle (e.g., temporarily or permanently on board the vehicle). In some implementations, the UE may be a vehicle.

In some embodiments, the first wireless node may include an RSU configured to transmit or receive data with the UE via V2X communication. The RSU 308b may be an example of the wireless node in one scenario. The RSU 310b may be an example of the wireless node in another scenario. The RSU 408c may be an example of the wireless node in another scenario.

Means for performing functionality at block 710 may comprise a wireless communication interface 930, wireless communication antenna(s) 932, and/or other components of an RSU, as illustrated in FIG. 9.

At block 720, the method 700 may include sending, by the wireless node, privilege information to the UE, privilege information configured to enable the UE to operate according to a set of behavioral rules associated with the first geographical region while the UE is within the first geographical region or within an overlap region that is created by a communication range of the wireless node and a communication range of another wireless node of another geographical region.

In some embodiments, the set of behavioral rules associated with the first geographical region may be determined by a regulatory authority governing the first geographical region. In some implementations, the set of behavioral rules may include a speed limit for the vehicle, usage of one or more special lanes by the vehicle, a waiting time for a traffic light, or a combination thereof.

Means for performing functionality at block 720 may comprise a wireless communication interface 930, wireless communication antenna(s) 932, and/or other components of an RSU, as illustrated in FIG. 9.

In this manner described by method 700, a base station (e.g., RSU managed by an authority of a geographical region) may grant privileges to a UE within the geographical region.

### Apparatus

FIG. 8 is a block diagram of an embodiment of a UE 105, which can be utilized as described herein above (e.g., in association with FIGS. 3-6). For example, the UE 105 can perform one or more of the functions of the method shown in FIG. 5 or 6. It should be noted that FIG. 8 is meant only to provide a generalized illustration of various components, any or all of which may be utilized as appropriate. It can be noted that, in some instances, components illustrated by FIG. 8 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 8.

The UE 105 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The UE 105 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The UE 105 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 830 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 810 or DSP 820.

The UE 105 may further include and/or be in communication with a memory 860. The memory 860 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the UE 105 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the UE 105 (and/or processor(s) 810 or DSP 820 within UE 105). In some embodiments, then, such code and/or instructions can be used to configure and/or adapt a general-purpose computer (or other device) to perform one or more operations in accordance with the described methods.

FIG. 9 is a block diagram of an embodiment of a base station 120, which can be utilized as described herein above (e.g., in association with FIGS. 3, 4 and 7). For example, the base station 120 can perform one or more of the functions of the method shown in FIG. 7, e.g., as an RSU. It should be noted that FIG. 9 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 905 (or may otherwise be in communication, as appropriate). The hardware elements may include a processor(s) 910 which can include without limitation one or more general-purpose processors, one or more special-purpose processors (such as DSP chips, graphics acceleration processors, ASICs, and/or the like), and/or other processing structure or means. As shown in FIG. 9, some embodiments may have a separate DSP 920, depending on desired functionality. Location determination and/or other determinations based on wireless communication may be provided in the processor(s) 910 and/or wireless communication interface 930 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 930 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 932 that send and/or receive wireless signals 934.

The base station 120 may also include a network interface 980, which can include support of wireline communication technologies. The network interface 980 may include a modem, network card, chipset, and/or the like. The network interface 980 may include one or more input and/or output communication interfaces to permit data to be exchanged with a network, communication network servers, computer systems, and/or any other electronic devices described herein.

In many embodiments, the base station 120 may further comprise a memory 960. The memory 960 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 960 of the base station 120 also may comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the base station 120 (and/or processor(s) 910 or DSP 920 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of receiving privileges at a user equipment (UE), the method comprising: based on a determination that the UE is within a first geographical region associated with a first authority, receiving first privilege information from a first wireless node within the first geographical region, the first privilege information comprising a first set of behavioral rules determined by the first authority; based on a determination that the UE is within an overlapping region, the overlapping region within a communication range of the first wireless node within the first geographical region and a communication range of a second wireless node within a second geographical region associated with a second authority, operating the UE according to the first set of behavioral rules; and receiving second privilege information from the second wireless node within the second geographical region, the second privilege information configured to enable the UE to operate according to a second set of behavioral rules determined by the second authority while within the second geographical region and not within the overlapping region.
Clause 2. The method of clause 1, wherein the UE comprises a mobile UE, the mobile UE comprising a vehicle, or co-located with the vehicle.
Clause 3. The method of any one of clauses 1-2 wherein the first privilege information is contained in a first privilege certificate that defines one or more locations at which the first set of behavioral rules applies to the vehicle; and the first set of behavioral rules comprises a speed limit for the vehicle, usage of one or more special lanes by the vehicle, a waiting time for a traffic light, or a combination thereof.
Clause 4. The method of any one of clauses 1-3 wherein the first wireless node comprises a first roadside unit (RSU) configured to transmit or receive data with the UE via vehicle-to-everything (V2X) communication; and the second wireless node comprises a second RSU configured to transmit or receive data with the UE via V2X communication.
Clause 5. The method of any one of clauses 1-4 further comprising, prior to the determination that the UE is within the overlapping region, operating the UE according to the first set of behavioral rules while within the first geographical region.
Clause 6. The method of any one of clauses 1-5 wherein the first authority and the second authority are associated with respective first and second regulatory entities governing the first geographical region and the second geographical region.
Clause 7. The method of any one of clauses 1-6 wherein the receiving of the second privilege information from the second wireless node is based on a determination that the UE is within the second geographical region and not within the overlapping region.
Clause 8. The method of any one of clauses 1-7 wherein the receiving of the second privilege information is prior to a determination that the UE is within the second geographical region.
Clause 9. The method of any one of clauses 1-8 further comprising, based on a determination that the UE is within the second geographical region and not within the overlapping region, switching, from the operation of the UE according to the first set of behavioral rules, to an operation of the UE that is based on the second set of behavioral rules; wherein the second set of behavioral rules is different from the first set of behavioral rules.
Clause 10. A user equipment (UE) comprising: a memory; and one or more processors communicatively coupled to the memory and configured to: based on a determination that the UE is within a first geographical region associated with a first authority, receive first privilege information from a first wireless node within the first geographical region, the first privilege information comprising a first set of behavioral rules determined by the first authority; based on a determination that the UE is within an overlapping region, the overlapping region within a communication range of the first wireless node within the first geographical region and a communication range of a second wireless node within a second geographical region associated with a second authority, operate the UE according to the first set of behavioral rules; and receive second privilege information from the second wireless node within the second geographical region, the second privilege information configured to enable the UE to operate according to a second set of behavioral rules determined by the second authority while within the second geographical region and not within the overlapping region.
Clause 11. The UE of clause 10, wherein the UE comprises a mobile UE, the mobile UE comprising a vehicle, or co-located with the vehicle.
Clause 12. The UE of any one of clauses 10-11 wherein the first privilege information is contained in a first privilege certificate that defines one or more locations at which the first set of behavioral rules applies to the vehicle; and the first set of behavioral rules comprises a speed limit for the vehicle, usage of one or more special lanes by the vehicle, a waiting time for a traffic light, or a combination thereof.
Clause 13. The UE of any one of clauses 10-12 wherein the first wireless node comprises a first roadside unit (RSU) configured to transmit or receive data with the UE via vehicle-to-everything (V2X) communication; and the second wireless node comprises a second RSU configured to transmit or receive data with the UE via V2X communication.
Clause 14. The UE of any one of clauses 10-13 wherein the one or more processors are further configured to, prior to the determination that the UE is within the overlapping region, operate the UE according to the first set of behavioral rules while within the first geographical region.
Clause 15. The UE of any one of clauses 10-14 wherein the first authority and the second authority are associated with respective first and second regulatory entities governing the first geographical region and the second geographical region.
Clause 16. The UE of any one of clauses 10-15 wherein the receipt of the second privilege information from the second wireless node is based on a determination that the UE is within the second geographical region and not within the overlapping region.
Clause 17. The UE of any one of clauses 10-16 wherein the receipt of the second privilege information is prior to a determination that the UE is within the second geographical region.
Clause 18. The UE of any one of clauses 10-17 wherein the one or more processors are further configured to, based on a determination that that the UE is within the second geographical region and not within the overlapping region, switching, from the operation of the UE according to the first set of behavioral rules, to an operation of the UE that is based on the second set of behavioral rules; wherein the second set of behavioral rules is different from the first set of behavioral rules.
Clause 19. A non-transitory computer-readable apparatus comprising a storage medium, the storage medium having instructions configured to, when executed by one or more processors, cause a user equipment (UE) to: based on a determination that the UE is within a first geographical region associated with a first authority, send first privilege information to a wireless node associated with the first geographical region, the first privilege information comprising a first set of behavioral rules determined by the first authority; operate the UE based on the first set of behavioral rules within the first geographical region; based on a determination that the UE is within an overlapping region, the overlapping region within a communication range of the first wireless node within the first geographical region and a communication range of a second wireless node within a second geographical region associated with a second authority, continue to operate the UE according to the first set of behavioral rules; and initiate communication with the second wireless node within the second geographical region to send second privilege information to the second wireless node, the second privilege information configured to enable the UE to operate according to a second set of behavioral rules determined by the second authority while within the second geographical region and not within the overlapping region.
Clause 20. The non-transitory computer-readable medium of clause 19, wherein the UE comprises a mobile UE, the mobile UE comprising a vehicle, or co-located with the vehicle.
Clause 21. The non-transitory computer-readable medium of any one of clauses 19-20 wherein the first wireless node comprises a first roadside unit (RSU) configured to transmit or receive data with the UE via vehicle-to-everything (V2X) communication; and the second wireless node comprises a second RSU configured to transmit or receive data with the UE via V2X communication.
Clause 22. The non-transitory computer-readable medium of any one of clauses 19-21 wherein the first authority and the second authority are associated with respective first and second regulatory entities governing the first geographical region and the second geographical region.
Clause 23. The non-transitory computer-readable medium of any one of clauses 19-22 wherein the sending of the second privilege information to the second wireless node is based on a determination that the UE is within the second geographical region and not within the overlapping region.
Clause 24. The non-transitory computer-readable medium of any one of clauses 19-23 wherein the set of behavioral rules comprises a speed limit for the vehicle, usage of one or more special lanes by the vehicle, a waiting time for a traffic light, or a combination thereof.
Clause 25. The non-transitory computer-readable medium of any one of clauses 19-24 wherein the instructions are further configured to, when executed by the one or more processors, cause the UE to: based on a determination that that the UE is within the second geographical region and not within the overlapping region, switch, from the operation of the UE according to the first set of behavioral rules, to an operation of the UE that is based on the second set of behavioral rules; wherein the second set of behavioral rules is different from the first set of behavioral rules.
Clause 26. The non-transitory computer-readable medium of any one of clauses 19-25 wherein the instructions are further configured to, when executed by the one or more processors, cause the UE to: determine a failure of the initiated communication with the second wireless node; based on the determination of the failure, implement one or more fallback processes to send the second privilege information, the one or more fallback processes comprising an increase of message priority with the second wireless node, allocation of more resources for the communication with the second wireless node, initiation of multiple communication with the second wireless node, initiation of communication with a third wireless node, or a combination thereof; and during the one or more fallback processes, operate according to a third set of behavioral rules.
Clause 27. An apparatus comprising: means for determining, by a wireless node within a first geographical region, a presence of a user equipment (UE) within a communication range of the wireless node; and means for sending, by the wireless node, privilege information to the UE, privilege information configured to enable the UE to operate according to a set of behavioral rules associated with the first geographical region while the UE is within the first geographical region or within an overlap region that is created by a communication range of the wireless node and a communication range of another wireless node of another geographical region.
Clause 28. The apparatus of clause 25, wherein the UE comprises a mobile UE, the mobile UE comprising a vehicle, or co-located with the vehicle.
Clause 29. The apparatus of any one of clauses 27-28 wherein the wireless nodes comprises a roadside unit (RSU) configured to transmit or receive data with the UE via vehicle-to-everything (V2X) communication.
Clause 30. The apparatus of any one of clauses 27-29 wherein the set of behavioral rules associated with the first geographical region is determined by a regulatory authority governing the first geographical region; and the set of behavioral rules comprises a speed limit for the vehicle, usage of one or more special lanes by the vehicle, a waiting time for a traffic light, or a combination thereof.

What is claimed is:

1. A method of receiving privileges at a user equipment (UE), the method comprising:
based on a determination that the UE is within a first geographical region associated with a first authority, receiving first privilege information from a first wireless node within the first geographical region, the first privilege information comprising a first set of behavioral rules determined by the first authority;
based on a determination that the UE is within an overlapping region, the overlapping region within a communication range of the first wireless node within the first geographical region and a communication range of a second wireless node within a second geographical region associated with a second authority, operating the UE according to the first set of behavioral rules; and
receiving second privilege information from the second wireless node within the second geographical region, the second privilege information configured to enable the UE to operate according to a second set of behavioral rules determined by the second authority while within the second geographical region and not within the overlapping region.

2. The method of claim 1, wherein the UE comprises a mobile UE, the mobile UE comprising a vehicle, or co-located with the vehicle.

3. The method of claim 2, wherein:
the first privilege information is contained in a first privilege certificate that defines one or more locations at which the first set of behavioral rules applies to the vehicle; and
the first set of behavioral rules comprises a speed limit for the vehicle, usage of one or more special lanes by the vehicle, a waiting time for a traffic light, or a combination thereof.

4. The method of claim 1, wherein:
the first wireless node comprises a first roadside unit (RSU) configured to transmit or receive data with the UE via vehicle-to-everything (V2X) communication; and
the second wireless node comprises a second RSU configured to transmit or receive data with the UE via V2X communication.

5. The method of claim 1, further comprising, prior to the determination that the UE is within the overlapping region, operating the UE according to the first set of behavioral rules while within the first geographical region.

6. The method of claim 1, wherein the first authority and the second authority are associated with respective first and second regulatory entities governing the first geographical region and the second geographical region.

7. The method of claim 1, wherein the receiving of the second privilege information from the second wireless node is based on a determination that the UE is within the second geographical region and not within the overlapping region.

8. The method of claim 1, wherein the receiving of the second privilege information is prior to a determination that the UE is within the second geographical region.

9. The method of claim 1, further comprising, based on a determination that the UE is within the second geographical region and not within the overlapping region, switching, from the operating of the UE according to the first set of behavioral rules, to operating the UE that is based on the second set of behavioral rules;
wherein the second set of behavioral rules is different from the first set of behavioral rules.

10. A user equipment (UE) comprising:
a memory; and
one or more processors communicatively coupled to the memory and configured to:
based on a determination that the UE is within a first geographical region associated with a first authority, receive first privilege information from a first wireless node within the first geographical region, the first privilege information comprising a first set of behavioral rules determined by the first authority;
based on a determination that the UE is within an overlapping region, the overlapping region within a communication range of the first wireless node within the first geographical region and a communication range of a second wireless node within a second geographical region associated with a second authority, operate the UE according to the first set of behavioral rules; and
receive second privilege information from the second wireless node within the second geographical region, the second privilege information configured to enable the UE to operate according to a second set of behavioral rules determined by the second authority while within the second geographical region and not within the overlapping region.

11. The UE of claim 10, wherein the UE comprises a mobile UE, the mobile UE comprising a vehicle, or co-located with the vehicle.

12. The UE of claim 11, wherein:
the first privilege information is contained in a first privilege certificate that defines one or more locations at which the first set of behavioral rules applies to the vehicle; and
the first set of behavioral rules comprises a speed limit for the vehicle, usage of one or more special lanes by the vehicle, a waiting time for a traffic light, or a combination thereof.

13. The UE of claim 10, wherein:
the first wireless node comprises a first roadside unit (RSU) configured to transmit or receive data with the UE via vehicle-to-everything (V2X) communication; and
the second wireless node comprises a second RSU configured to transmit or receive data with the UE via V2X communication.

14. The UE of claim 10, wherein the one or more processors are further configured to, prior to the determination that the UE is within the overlapping region, operate the UE according to the first set of behavioral rules while within the first geographical region.

15. The UE of claim 10, wherein the first authority and the second authority are associated with respective first and second regulatory entities governing the first geographical region and the second geographical region.

16. The UE of claim 10, wherein the receipt of the second privilege information from the second wireless node is based on a determination that the UE is within the second geographical region and not within the overlapping region.

17. The UE of claim 10, wherein the receipt of the second privilege information is prior to a determination that the UE is within the second geographical region.

18. The UE of claim 10, wherein the one or more processors are further configured to, based on a determination that that the UE is within the second geographical region and not within the overlapping region, switching, from the operation of the UE according to the first set of behavioral rules, to an operation of the UE that is based on the second set of behavioral rules;
wherein the second set of behavioral rules is different from the first set of behavioral rules.

19. A non-transitory computer-readable apparatus comprising a storage medium, the storage medium having instructions configured to, when executed by one or more processors, cause a user equipment (UE) to:
based on a determination that the UE is within a first geographical region associated with a first authority, send first privilege information to a first wireless node associated with the first geographical region, the first privilege information comprising a first set of behavioral rules determined by the first authority;
operate the UE based on the first set of behavioral rules within the first geographical region;
based on a determination that the UE is within an overlapping region, the overlapping region within a communication range of the first wireless node within the first geographical region and a communication range of a second wireless node within a second geographical region associated with a second authority, continue to operate the UE according to the first set of behavioral rules; and
initiate communication with the second wireless node within the second geographical region to send second privilege information to the second wireless node, the second privilege information configured to enable the UE to operate according to a second set of behavioral rules determined by the second authority while within the second geographical region and not within the overlapping region.

20. The non-transitory computer-readable apparatus of claim 19, wherein the UE comprises a mobile UE, the mobile UE comprising a vehicle, or co-located with the vehicle.

21. The non-transitory computer-readable apparatus of claim 19, wherein:
the first wireless node comprises a first roadside unit (RSU) configured to transmit or receive data with the UE via vehicle-to-everything (V2X) communication; and
the second wireless node comprises a second RSU configured to transmit or receive data with the UE via V2X communication.

22. The non-transitory computer-readable apparatus of claim 19, wherein the first authority and the second authority are associated with respective first and second regulatory entities governing the first geographical region and the second geographical region.

23. The non-transitory computer-readable apparatus of claim 19, wherein the sending of the second privilege information to the second wireless node is based on a determination that the UE is within the second geographical region and not within the overlapping region.

24. The non-transitory computer-readable apparatus of claim 19, wherein the first set of behavioral rules comprises a speed limit for a vehicle, usage of one or more special lanes by the vehicle, a waiting time for a traffic light, or a combination thereof.

25. The non-transitory computer-readable apparatus of claim 19, wherein the instructions are further configured to, when executed by the one or more processors, cause the UE to:
based on a determination that that the UE is within the second geographical region and not within the overlapping region, switch, from the operation of the UE according to the first set of behavioral rules, to an operation of the UE that is based on the second set of behavioral rules;
wherein the second set of behavioral rules is different from the first set of behavioral rules.

26. The non-transitory computer-readable apparatus of claim 19, wherein the instructions are further configured to, when executed by the one or more processors, cause the UE to:
determine a failure of the initiated communication with the second wireless node;
based on the determination of the failure, implement one or more fallback processes to send the second privilege information, the one or more fallback processes comprising an increase of message priority with the second wireless node, allocation of more resources for the communication with the second wireless node, initiation of multiple communication with the second wireless node, initiation of communication with a third wireless node, or a combination thereof; and
during the one or more fallback processes, operate according to a third set of behavioral rules.

27. An apparatus comprising:
means for determining, by a wireless node within a first geographical region, a presence of a user equipment (UE) within a communication range of the wireless node; and
means for sending, by the wireless node, privilege information to the UE, privilege information configured to enable the UE to operate according to a set of behavioral rules associated with the first geographical region while the UE is within the first geographical region or within an overlap region that is created by a communication range of the wireless node and a communication range of another wireless node of another geographical region.

28. The apparatus of claim 27, wherein the UE comprises a mobile UE, the mobile UE comprising a vehicle, or co-located with the vehicle.

29. The apparatus of claim 27, wherein the wireless node comprises a roadside unit (RSU) configured to transmit or receive data with the UE via vehicle-to-everything (V2X) communication.

30. The apparatus of claim 27, wherein:
the set of behavioral rules associated with the first geographical region is determined by a regulatory authority governing the first geographical region; and
the set of behavioral rules comprises a speed limit for a vehicle, usage of one or more special lanes by the vehicle, a waiting time for a traffic light, or a combination thereof.
